(19) United States
(12) Patent Application Publication
(10) Pub. No.: US 2017/0323092 A1
(43) Pub. Date: Nov. 9, 2017

(54) METHOD AND SYSTEM OF USING SPATIALLY-DEFINED AND PATTERN-DEFINED GESTURING PASSWORDS

(71) Applicant: General Electric Company, Schenectady, NY (US)

(72) Inventors: Pavan Kumar Singh Thakur, Hyderabad (IN); Jagadeesh Jinka, Hyderabad (IN); Chaithanya Guttikonda, Hyderabad (IN)

(21) Appl. No.: 15/145,073

(22) Filed: May 3, 2016

(51) Int. Cl. G06F 21/36; G06F 3/0484; G06F 3/0482; G06F 3/0488

(52) U.S. Cl. CPC G06F 21/36; G06F 3/04847; G06F 3/04883; G06F 3/0482; G06F 3/04842; G06F 2203/04804

(57) ABSTRACT

Exemplified herein is a system and method to accept password on a touch-screen HMI (human-machine interface) device. The system and method uses a combination of tactile gestures that are each received at predefined quadrants (or regions) or the touch-screen. The combination of such tactile gestures and quadrant information are used as an authentication sequence to allow or enable access to control screens that manages operations of a nearby subsystem.

### FIELD OF THE DISCLOSURE

Embodiments of the disclosure generally relate to controls of industrial systems, and more particularly methods and systems for managing security for a group of controllers.

### BACKGROUND

In distributed industrial control systems, local controllers with human-machine interfaces (HMIs) may be placed near individual subsystems to which they provide associated control, management, supervision, and operation functions to the subsystem or groups thereof. Examples of industrial control applications include those in power plants, factories, refineries, power distribution sites, wind or solar farms, among others. Because of the harsh and tumultuous physical conditions associated with industrial environments, ruggedized HMI are used.

Secured operation is a requirement of industrial applications to safeguard against intrusion and disruption of the infrastructure and provided services. In addition, operation with lower spatial input resolution is also a requirement as gloves and protective gear are often used in such environments.

What are needed are devices, systems and methods that overcome challenges in the present art, some of which are described above.

### SUMMARY

Exemplified herein are systems and methods to accept gesturing passwords and user commands on a touch-screen HMI (human-machine interface) device. The system and method uses a combination of tactile gestures that are each received at spatially-defined regions (e.g., quadrants) of the touch-screen.

In some embodiments, the combination of such tactile-gesture-patterns and spatially-defined regions (e.g., quadrant), as inputted to a touch-screen, are used as an authentication sequence to allow or enable access to control screens that manages operations of a nearby subsystem. The inputs facilitates the use of sequences of shapes and screen locations in combination with one another to form a gesturing password. Rather than using complex codes, the gesturing password facilitates a more intuitive means to access the device and also reduce the chance of an incorrect input, e.g., via touch-screen keyboard keys or pointing device. In addition, the input are received, in some embodiments, on a transparent screen that allows the underlying control screens to be viewed. This allows the control screens to remain locked thereby securing the control screens from sabotage or inadvertent operation, while allowing the underlying control notification and report to be viewed. In other embodiments, the control screen receives the input, but is configured to not invoke actions (e.g., being in a locked- or non-active state) on underlying input widgets until an authenticating input is provided.

In some embodiments, the combination of such tactile gestures and quadrant inputs are used as invocation sequence (as a shortcut) to invoke a command or access to a panel that may require several actions to be invoked. To this end, the tactile gestures and associated quadrant input facilitates user navigation and execution of programmable elements in a touch based device (i.e., a controller) without lengthy touch interaction sequence to execute a command/operation on the touch based device.

According to an aspect, a method of receiving a sequence of spatially- and pattern-defined touch inputs, at a graphical user interface, of a touch-screen input device, in an industrial automation system, as a touch-based password (also referred to as a gesturing password) for an operating system or an application executing on the device is disclosed. Herein, password (as well as gesturing password) is a sequence of input-actions (i.e., corresponding to lines or points inputs having temporal components associated with a gesturing tap or gesturing swipe), shapes, or symbols that are associated to a spatially-defined region of a touchscreen that are used to gain admission or acceptance to the device or executing application.

The method includes presenting, by a processor, via a touch-screen display of the touch-screen input device, a plurality of transparent widgets (e.g., an object generated and monitored for tactile input in the rendered display or a virtual region in the rendered display monitored for tactile input), each located at an area spanning a pre-defined quadrant of the presented display; upon receipt, via the touch-screen display, of a plurality of inputs at a plurality of positions corresponding to the plurality of transparent widgets, determining, by the processor, for each received input, a determined touch pattern, among a plurality of stored touch patterns, derived from the respective received input; comparing, by the processor, a sequence of determined touch patterns to at least one password sequences of touch patterns, wherein each sequence is associated with access to an application or operating-system function-call; and upon a match, causing, by the processor, execution of the application or operating-system function-call associated with a successful authenticated input.

In some embodiments, each of the plurality of password sequence of touch patterns comprises a number of unique touch patterns selected from the group consisting of 2, 3, 4, 5, 6, 7, 8, 9, 10, 11, 12, 13, 14, 15, and 16.

In some embodiments, a successful authenticated input includes a determined touch pattern in each of the plurality of presented transparent widgets.

In some embodiments, a successful authentication input includes a determined touch pattern in at least two of the plurality of presented transparent widgets.

In some embodiments, the determined touch pattern comprises a contiguous pattern selected from the group consisting of a point, a line, an arc, a symbol (e.g., an alpha-numerical character), and a polygonal shape (e.g., a box, a circle, a triangle, a parallelogram, a rectangle, a rhomboid, etc.).

In some embodiments, the determined touch pattern comprises two or more contiguous patterns, each selected from the group consisting of a point, a line, an arc, a symbol (e.g., an alpha-numerical character), and a polygonal shape (e.g., wherein the two or more continuous patterns, collectively, form a motion (e.g., pinching gesture) or a symbol (e.g., “=”, “X”, a double circle, etc.)).

In some embodiments, upon determining the successful authenticated input, the method includes presenting one or more control widgets each associated with a control function-call of a control application for the industrial automation system; and in response to an input being received at a control widget of the one or more control widgets, cause execution of an associated control function-call associated with the control widget. In some embodiments, the method includes, upon receipt, via the touch-screen display, of a second input i) originating at a first position on the presented display associated with a first transparent widget presented at a first quadrant and ii) terminating at a second position on the presented display associated with a second transparent widget presented at a second quadrant, determining, by the processor, i) a multi-quadrant touch pattern, derived from the second input, and ii) transparent-widget pair locations, among the pre-defined quadrants, derived from the received positions; and caching, by the processor, the determined multi-quadrant touch pattern and quadrant positions associated therewith as an element in a determined sequence.

In some embodiments, the method includes, upon receipt, via the touch-screen display, of a third input having traversed across i) a first transparent widget presented at a first quadrant, ii) a second transparent widget presented at a second quadrant, and iii) a third transparent widget presented at a third quadrant, determining, by the processor, i) a tri-quadrant touch pattern, derived from the third input, and ii) at least three transparent-widget locations, among the pre-defined quadrants, derived from the received positions; and caching, by the processor, the determined tri-quadrant touch pattern and quadrant positions associated therewith as an element in a determined sequence.

In some embodiments, the method includes presenting, by the processor, via the touch-screen display, a visual representation of a graphical element at a border region between each neighbor transparent widgets among the plurality of transparent widgets.

In some embodiments, the method includes presenting, by the processor, via the touch-screen display, a visual representation of a determined touch pattern being received (e.g., after each touch pattern is received).

In some embodiments, the visual representation comprises a graphical element having a pattern of the determined touch pattern.

In some embodiments, the method includes presenting, by the processor, via the touch-screen display, a visual representation of a graphical element associated with a submit password for authentication.

In some embodiments, the method includes presenting, by the processor, a visual representation of a password configuration window, the password configuration window having a plurality of selectable input fields, including a first selectable input field and a second selectable input field, wherein the first selectable input field includes a list of one or more quadrants associated with execution of a password, and wherein the second selectable input field includes a list of touch patterns, to be used in conjunction with the selected one or more quadrants selected in the first selectable input field, the selected touch pattern being associated with the password.

In some embodiments, the plurality of selectable input fields of the password configuration window comprises a third selectable input field, wherein the third selectable input field includes a list of configuration options to associate to a specific password.

In some embodiments, the method includes presenting, by the processor, in the password configuration window, a visual representation of a password sequence derived from each inputs to the plurality of selectable input fields.

In some embodiments, the method (e.g., presenting a dialog wizard to input a touch-based password sequence, each dialog box accepting one touch-input for the password sequence), includes presenting, by the processor, a visual representation of a first password configuration dialog box, the first dialog box including a first selectable input field and a second selectable input field, wherein the first selectable input field includes a list of one or more quadrants associated with execution of a password, and wherein the second selectable input field includes a list of touch patterns, to be used in conjunction with the selected one or more quadrants selected in the first selectable input field, the selected touch pattern being associated with a first touch-pattern in a sequence of touch-patterns defining a touch-based password; and upon receipt of inputs for each of the first and second selectable fields, presenting, by the processor, a visual representation of a second password configuration dialog box, the second dialog box including a third selectable input field and a fourth selectable input field, wherein the third selectable input field includes a list of one or more quadrants associated with execution of a password, and wherein the fourth selectable input field includes a list of touch patterns, to be used in conjunction with the selected one or more quadrants selected in the third selectable input field, the selected touch pattern being associated with a second gesture in the sequence of gestures defining the gesture-based password.

In some embodiments, the method includes interrogating for a touch-based password for each control command selected from the group consisting of viewing a HMI screen, setting control values or parameters associated with operation of an equipment within the industrial automation system, and changing configuration of the touch-screen input device (e.g., change LCD brightness levels).

In some embodiments, the method includes presenting, by the processor, via the touch-screen display, a graphical widget to input a text-based password; and in response to selection of the graphical widget, presenting, via the touch-screen display, a dialog box to receive a text-based password.

In another aspect, an apparatus (e.g., in an industrial automation system) is disclosed that authenticates a password inquiry via a touch-based password comprising a sequence of spatially- and pattern-defined touch inputs, at a graphical user interface of the apparatus. The apparatus includes a touch-screen display; a processor operatively coupled to the touch-screen display; and a memory operatively coupled to the processor, the memory having instructions stored thereon, wherein the instructions, when executed by the processor, cause the processor to: present, via the touch-screen display, a plurality of transparent widgets, each located at an area spanning a pre-defined quadrant of the presented display; upon receipt, via the touch-screen display, of a plurality of inputs at a plurality of positions corresponding to the plurality of transparent widgets, determine, for each received input, a determined touch pattern, among a plurality of stored touch pattern, derived from the respective received input; compare a sequence of determined touch patterns to at least one password sequence of touch patterns, wherein each sequence is associated with access to an application or operating-system function-call; and upon a match, cause execution of the application or operating-system function-call associated with a successful authenticated input.

In another aspect, a non-transitory computer-readable medium that authenticates a password inquiry via a touch-based password comprising a sequence of spatially- and pattern-defined inputs, at a graphical user interface, received at a touch-screen input is disclosed. The computer-readable medium has instructions stored thereon, wherein the instructions, when executed by the processor, cause the processor to: present, via the touch-screen display, a plurality of transparent widgets, each located at an area spanning a pre-defined quadrant of the presented display; upon receipt, via the touch-screen display, of a plurality of inputs at a plurality of positions corresponding to the plurality of transparent widgets, determine for each received input, a determined touch pattern, among a plurality of stored touch pattern, derived from the respective received input; compare a sequence of determined touch patterns to a plurality of password sequence of touch patterns, wherein each sequence is associated with access to an application or operating-system function-call; and upon a match, cause execution of the application or operating-system function-call associated with a successful authenticated input.

In another aspect, a method of receiving a sequence of spatially- and pattern-defined touch inputs, at a graphical user interface, of a touch-screen input device, in an industrial automation system, as a touch-based password for an operating system or an application executing on the device. The method includes presenting, by a processor, via a touch-screen display of the touch-screen input device, a plurality of widgets for a control application in an industrial automation system, wherein each of the plurality of widgets is associated with a control function call of the control application and is presented in a non-responsive state; upon receipt, via the touch-screen display, of a plurality of inputs at a plurality of positions, at the graphical user interface, determining, by the processor, for each received input, i) a determined touch pattern, among a plurality of stored touch patterns, derived from the respective received input and ii) an associated pre-defined quadrant of the presented display, wherein each associated pre-defined quadrant is associated with a given determined touch pattern, and wherein each pre-defined quadrant spans a pre-defined area over the graphical user interface; comparing, by the processor, a sequence of determined touch patterns to at least one password sequences of touch patterns, wherein each sequence is associated with access to an application or operating-system function-call; and upon a match, causing, by the processor, each of the plurality of widgets to be presented in a responsive state such that a receipt of an input at the plurality of widgets causes execution of the associated control function-call of the control application.

### BRIEF DESCRIPTION OF THE DRAWINGS

The components in the drawings are not necessarily to scale relative to each other and like reference numerals designate corresponding parts throughout the several views:

FIG. 1 depicts an example graphical user interface (GUI) configured to receive spatially- and pattern-defined touch input, in accordance with an illustrative embodiment.

FIGS. 2-6, comprising FIGS. 2, 3, 4, 5, and 6, each depicts an example spatially- and pattern-defined touch input, in accordance with an illustrative embodiment.

FIG. 7, comprising panels 7A, 7B, 7C, 7D, 7E, 7F, 7G, and 7H, illustrates example symbol patterns that include stroke ordering.

FIG. 8 depicts an example graphical user interface (GUI) configured to receive spatially- and pattern-defined touch input, in accordance with another illustrative embodiment.

FIGS. 9-11, comprising FIGS. 9, 10, and 11, depict diagrams of a user interface to create a gesturing password, in accordance with an illustrative embodiment.

FIGS. 12 and 13, comprising FIGS. 12, 13A, and 13B, depict diagrams of a user interface to create a gesturing password, in accordance with another illustrative embodiment.

FIG. 14 depicts a method of receiving a sequence of spatially- and pattern-defined touch inputs, at a graphical user interface, of a touch-screen input device, in an industrial automation system, as a touch-based password for an operating system or an application executing on the device.

FIGS. 15, 16, 17, and 18, each depicts a diagram illustrating an exemplary embodiments of configuration of divided regions (i.e., Quadrant), in accordance with an illustrative embodiment.

FIG. 19 depicts an example graphical user interface (GUI) configured to receive spatially- and pattern-defined touch input shortcut, in accordance with an illustrative embodiment, for example, for example, for use in association with an industrial automation system.

FIG. 20 depicts a method of receiving a sequence of spatially- and pattern-defined touch inputs, at a graphical user interface, of a touch-screen input device, in an industrial automation system, to trigger an associated user interface command (i.e. as a touch-based shortcut), in accordance with an illustrative embodiment.

FIG. 21 depicts a diagram of an example process to invoke an associated executable command or to open an associated configuration panel.

FIG. 22 illustrates an exemplary computer that can be used for configuring hardware devices in an industrial automation system.

FIGS. 23 and 24 are diagrams of example industrial automation systems, in accordance with an illustrative embodiment.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

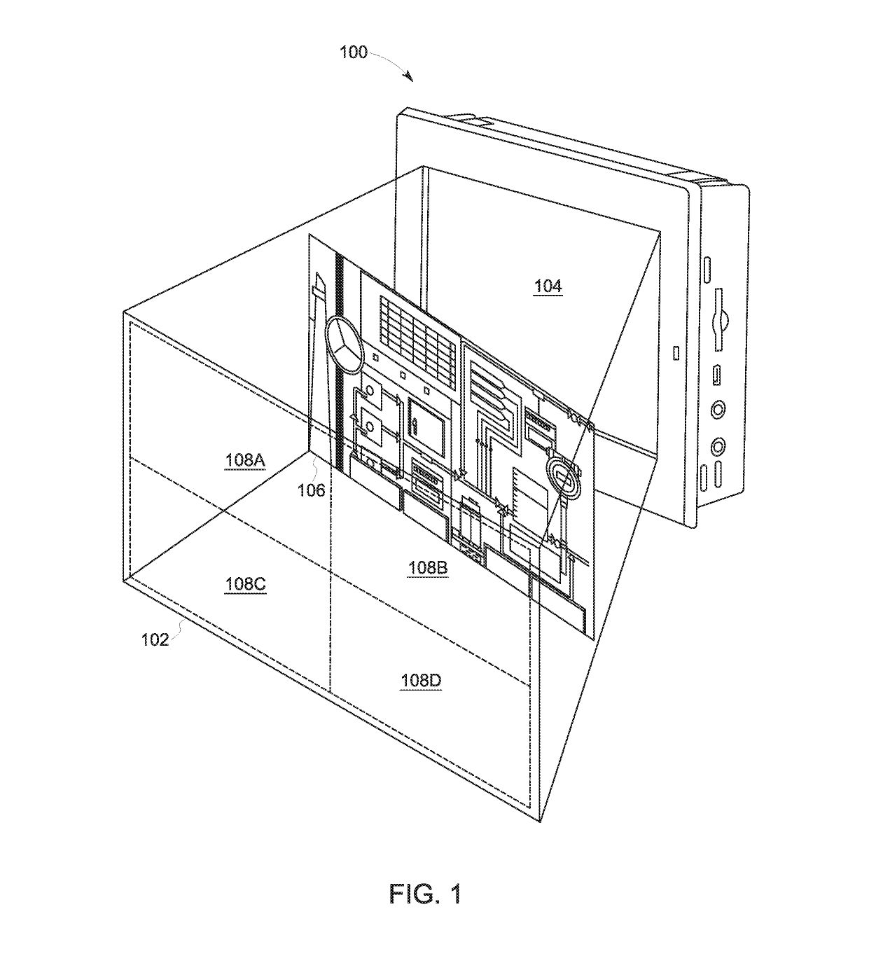

FIG. 1 depicts an example graphical user interface (GUI) configured to receive spatially- and pattern-defined touch input, in accordance with an illustrative embodiment, for example, for use in association with an industrial automation system.

In some embodiments, the industrial automation system includes programmable logic controllers (PLCs), supervisory control and data acquisition (SCADA) systems, and programmable automation controllers (PACs), safety instrumented systems (SISs), and the like, (collectively forming a distributed I/O system) for controlling power generation systems and/or machinery in an industrial automation application. One or more of the PLC, SCADA, and PAC controllers may be configurable to receive input-output modules, as well as submodules, that provides input and output channels to controllable elements (e.g., sensors and actuators) in the system. In some embodiments, the PLC, SCADA, and PAC controllers, and network directing elements (e.g., switches and routers) connected thereto, are configured to provide, over a communication link, to components (e.g., the development workspace) in the network, hardware description data and device configuration data associated with the controllers. In some embodiments, the communication link is provided over industrial protocols, such as Profinet, Profibus, InterCAD, FieldBus, and the like.

The exemplified system associates spatial regions of a touch screen as virtual quadrants that receives a pattern submitted thereon as a gesturing password that is a combination of gestures applied on each of the quadrants. In FIG. 1, a computing device 100 generates, via an application, an input screen 102 (e.g., a prompt window), via the graphical user interface 104, that renders over or defined within a control screen 106. That is, the input screen 102, in some embodiments, includes a separate layer or panel that is transparent and generated over a live control screen 106 (that is, an input received at the control screen causes widgets therein to be invoked). The separate layer or panel, in some embodiments, is generated via an operation system service or via an application executing in parallel or in conjunction with the control application associated with the screen.

In other embodiments, this input screen 102 is replicated in the control screen 106 in that the control screen 106 limits acceptance of inputs for authentication purposes, and input-based widgets associated with the control screen 106 are configured to not to respond to such inputs until a lock flag, or the like (e.g., a non-active state flag), is modified following the authentication input.

Referring still to FIG. 1, the input screen 102 is divided into multiple zones, each configured to receive inputs at multiple associated spatial regions 108 (shown as regions 108a, 108b, 108c, and 108d) to which the combination of each input pattern at respective associated spatial regions, collectively, define a sequence of spatial-specific pattern.

Example Spatially- and Pattern-Defined Touch Input Sequences

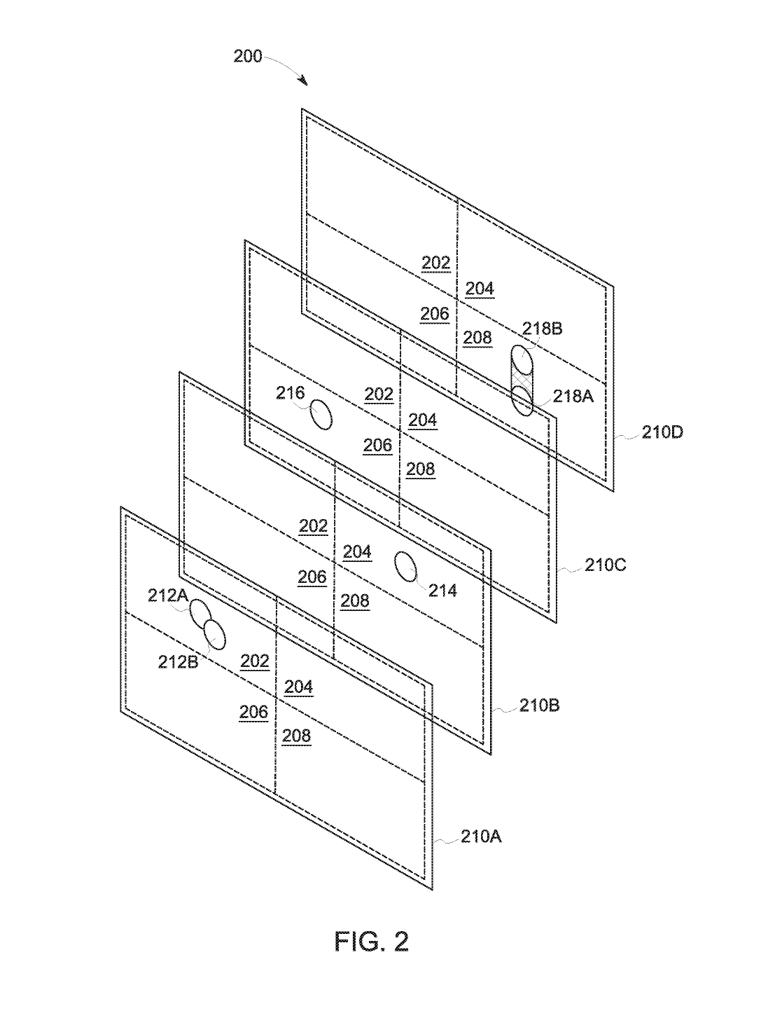

FIGS. 2-6, comprising FIGS. 2, 3, 4, 5, and 6, each depicts an example spatially- and pattern-defined touch input, in accordance with an illustrative embodiment.

In FIG. 2, an example spatially- and pattern-defined touch input sequence 200 includes a “double tap” in a first quadrant of the GUI followed by a “single tap” in the second quadrant followed by a “single tap” in a third quadrant followed by a “swipe” in the fourth quadrant. As shown in FIG. 2, the “double tap” in the first quadrant includes two consecutive point-based inputs (shown as 212a and 212b) received at an upper-left region 202 (quadrant 1). The input coordinates 212a, 212b each registers as a narrow field within a small variation from each other (e.g., the spatial median between each of the two inputs are less than one-half the size of narrow field) and each are received within a pre-defined time from one another (e.g., less than 0.5 second). In sequence 210b, a single point-based input (shown as 214) is received at an upper-right region 204 (quadrant 2). In sequence 210c, a single point-based input (shown as 216) is received at a lower-left region 206 (quadrant 3). In sequence 210d, a multi-point-based input (shown as 218) is received at a lower-right region 208 (quadrant 3); the multi-point-based input includes multiple input points received as a line in which all of the points are received within a defined-time (e.g., less than 0.5 second). The beginning and end points are shown as points 218a, 218b.

As shown in FIG. 2, the specific location of the input coordinates for a double tap is not used to exclude a given input as meeting the input pattern so long as the inputs are received in the specific region (i.e., quadrant) of the screen. In addition, the specific angle, specific line length for a swipe is not used in the determination. For a swipe action, only a minimum length threshold and a time parameter to receive the inputs are used, in some embodiments.

In some embodiments, the geometrically determined center of the narrow fields from the inputs are used to determine the pattern.

This example spatially- and pattern-defined touch input sequence of FIG. 2, and other figures disclosed herein, are received, via the GUI, of a computing device. The computing device has a memory having instructions stored thereon, wherein when executed by a processor, cause the processor to present control screen on the GUI, receive inputs from the same GUI, and determine a spatially- and pattern-defined touch input pattern using the inputs. The instructions, when executed by the processor, cause the processor to receive multiple of these spatially- and pattern-defined touch input patterns, which collectively form the spatially- and pattern-defined touch input sequence that is compared to a pre-defined set of one or more pattern-defined touch input sequences that would provide authentication to the control screen.

In other embodiments, the pattern-defined touch input sequence is compared to a pre-defined set of one or more pattern-defined touch input sequences to invoke an operating system event or an application action, for example, invoke execution of a command or widget associated with the application, invoke execution of an application, and invoke opening of an operation system or application based control menu or panel.

The number of spatially- and pattern-defined touch input sequences to form a gesturing password, in some embodiments, is between 1 and 10 sequences, including 1, 2, 3, 4, 5, 6, 7, 8, 9, and 10. In some embodiments, the preferred number of sequences for a given gesturing password is less than 6. In some embodiments, a gesturing password may include more than 10 spatially- and pattern-defined touch input sequences.

Quadrants as used herein refers to any of such divided regions of the touch screen and such division can be in 2, 3, 4, 5, 6, 7, 8, 9, 10, 11, or 12 divisions. Quadrants are also referred to herein as input regions.

In some embodiments, the GUI receives input via a touch class, e.g., the system.windows.input class in PresentationCore.dll (for Windows). In some embodiments, the GUI receives via libinput library in Linux. In some embodiments, the GUI may operate in conjunction with a multi-touch gesture program such as Touchegg, or other multitouch gesture programs, that runs as a user in the background, and adds multitouch support to the window managers.

Example Simultaneous Multi-Input Patterns

In addition to “swipe”, “double tap”, and “single tap” input patterns, other spatially- and pattern-defined touch input patterns that may be maintained in memory and compared thereto by the processor include “pinch-in” action, “pinch-out” action. In some embodiments, the GUI may be configured to receive and determine a “vertical line” input pattern or a “horizontal line” input pattern. “Vertical line” and “horizontal line” input patterns may have lax, or not have, an input time requirement—rather than an angle input tolerance and/or variation tolerance requirement.

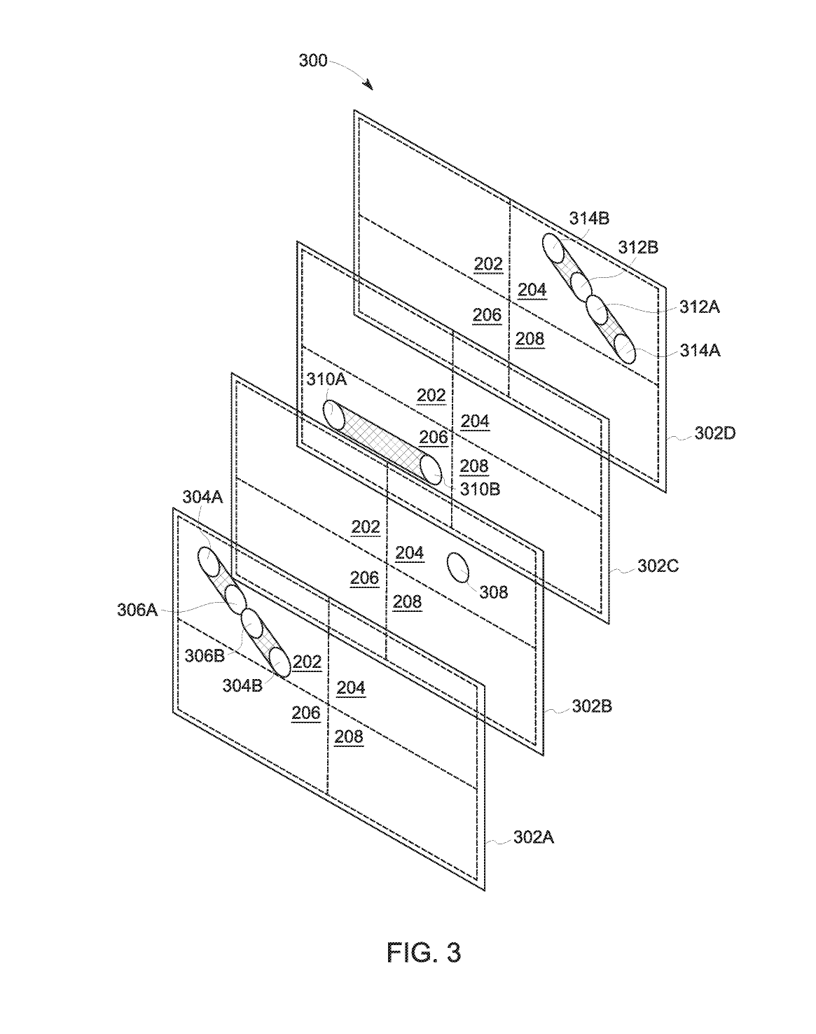

In FIG. 3, an example spatially- and pattern-defined touch input sequence 300 includes a “pinch-in” in the first quadrant followed by a “single tap” in the second quadrant followed by a “swipe” in the third quadrant followed by a “pinch-out” in the fourth quadrant. As shown in FIG. 3, the “pinch-in” pattern received, in the first sequence 302a, in the first quadrant, includes multiple input points received as two lines that converged to each other. In some embodiments, each of the lines includes a first entry point (shown as 304a and 304b) and ends at exit points (shown as 306a and 306b, respectively). The angle of the lines, in some embodiments, are not used for the determination of the pattern. In some embodiments, subclasses of the pinch-in and pinch-out patterns, such as horizontal pinch-in/out and vertical pinch-in/out, use angles of the lines as a criterion in the determination of a pattern. In the second sequence 302b, a single point-based input 308, similar to the description provided in relation to FIG. 2, is received at the upper-right region (Quadrant 2). In the third sequence 302c, the multi-point-based input corresponding to a “swipe”, as described in relation to FIG. 2, is received at the lower-left region (Quadrant 3); the multi-point-based input includes multiple input points received as a line in which all of the points are received within a defined-time (e.g., less than 0.5 second). The beginning and end points are shown as points 310a, 310b. In the fourth sequence 302d, the “pinch-out” pattern received, in the second quadrant, includes multiple input points received as two lines that diverged from each other. In some embodiments, each of the lines includes a first entry point (shown as 312a and 312b) and ends at exit points (shown as 314a and 314b, respectively). The angle of the lines, in some embodiments, are not used for the determination of the pattern.

Example Multi-Quadrant Patterns

In addition, spatially- and pattern-defined touch input patterns that are maintained in memory and compared thereto by the processor may include patterns that extend across multiple regions and geometrically-relevant patterns (e.g., accounting for angles of a path defined by the respective inputs).

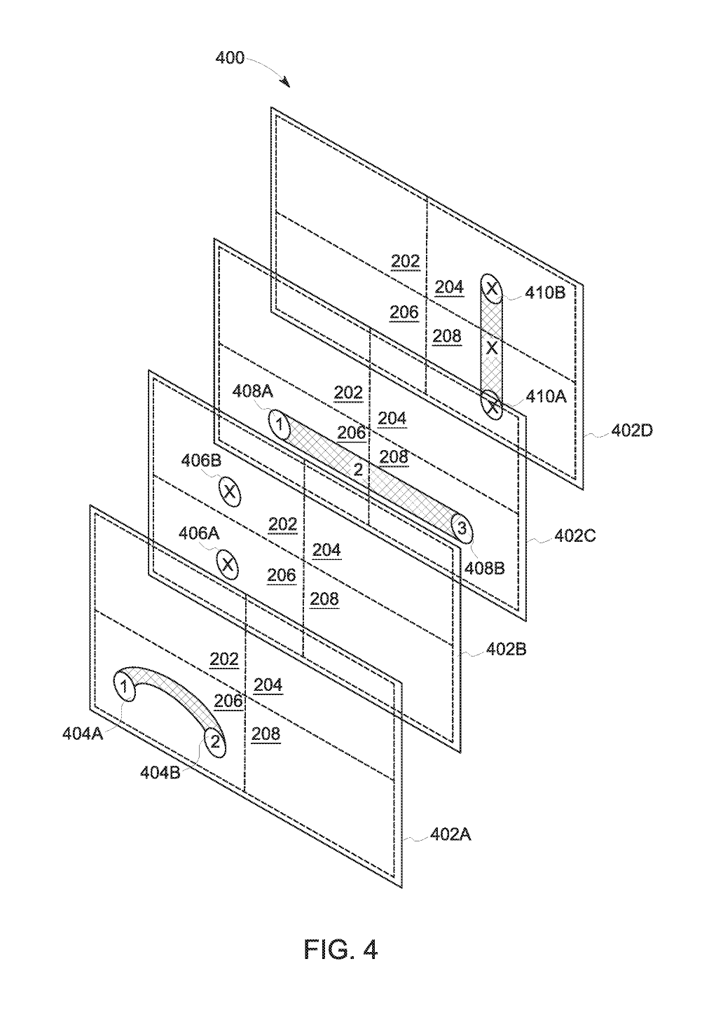

In FIG. 4, an example spatially- and pattern-defined touch input sequence includes a curved-line input, a multi-point multi-quadrant input, a multi-quadrant swipe action, and a multi-quadrant line symbol. In FIG. 4, an example spatially- and pattern-defined touch input sequence 400 includes a “curved line” in the third quadrant followed by a “tap-hold-and-tap” in the first and third quadrant followed by a horizontal “intra-quadrant swipe” between the third and fourth quadrant followed by a vertical “intra-quadrant swipe” in between the fourth and second quadrant. As shown in FIG. 4, the “curved line” pattern received, in the first sequence 402a, at the third quadrant (e.g., 206), includes multiple input points received as a curved line in which all of the points are received within a defined-time (e.g., less than 0.5 second). The beginning and end points are shown as points 404a, 404b.

In the second sequence 402b, a “tap-hold-and-tap” input is received at the first and third quadrant. The “tap-hold-and-tap” pattern includes a first input, say input 406a, at one of two pre-defined points. While the first input 406a is held, a second input 406b is received. There are generally no time limit, in some embodiments, between receipt of the first input 406a and the second input 406b. In other embodiments, a time limit (e.g., 2 or 3 seconds) for receipt of the first input 406a and the second input 406b is specified. As shown in FIG. 4, the “tap-hold-and-tap” pattern may specify an order-agnostic input among the first and second inputs. That is, to have a valid match, either inputs (e.g., 406a or 406b) can be received first followed by the corresponding inputs.

In the third sequence 402c, a horizontal “intra-quadrant swipe” between the third and fourth quadrant is received. The horizontal “intra-quadrant swipe” pattern includes an entry input 408a at a first quadrant (as shown here, Quadrant 3), and the input is maintained between the entry input 408a at the entry quadrant to an exit input 408b at an exit quadrant (shown as Quadrant 4). As shown in FIG. 4, the pattern specifies an order for the entry and exit input. To this end, inputs that are received in the opposite order do not match that pattern.

In the fourth sequence 402d, a vertical “intra-quadrant swipe” between the fourth and second quadrant is received at the third and fourth quadrant. Similar to a horizontal “intra-quadrant swipe”, as discussed in relation to sequence 402c, the vertical “intra-quadrant swipe” pattern includes an entry input 410a at a first quadrant (as shown here, Quadrant 3), and the input is maintained between the entry input 410a at the entry quadrant to an exit input 410b at an exit quadrant (shown as Quadrant 4). As shown in FIG. 4, the pattern specifies an order-agnostic input among the entry and exit inputs. That is, to have a valid match, either inputs (e.g., 410a or 410b) can be received first followed by the corresponding inputs.

Example Shape and Symbol Patterns

In addition, spatially- and pattern-defined touch input patterns that are maintained in memory and compared thereto by the processor may include shaped patterns (e.g., box, circle, triangle) and/or symbols (e.g., alpha-numerical symbols and various known symbols).

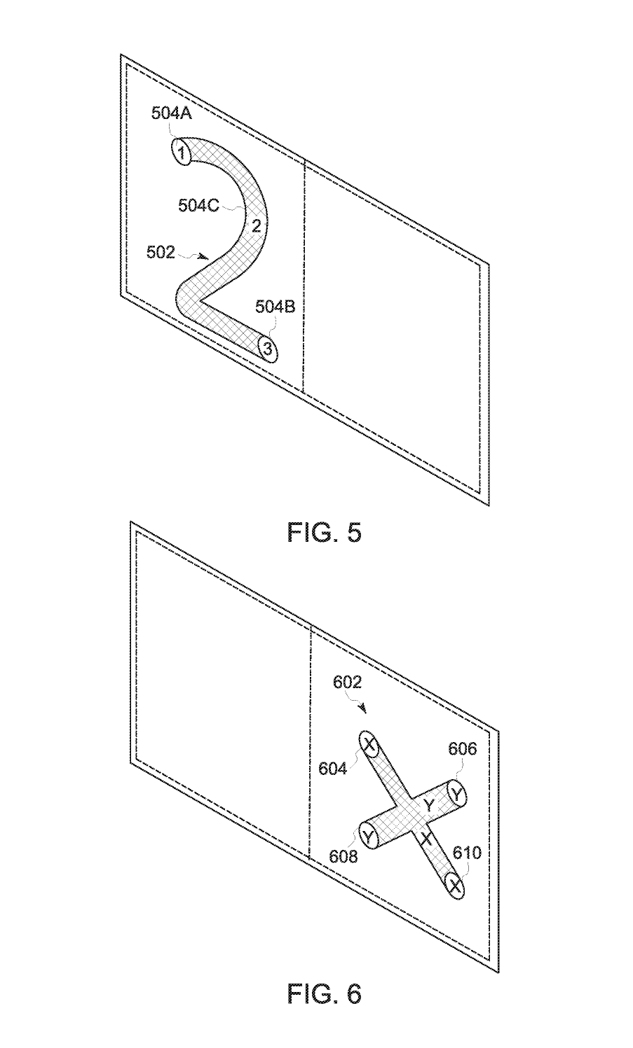

In FIGS. 5 and 6, an example spatially- and pattern-defined touch input sequence includes a symbol (e.g., an alpha-numerical symbol). In some embodiments, the symbol is defined geometrically and by stroke orders.

As shown in FIG. 5, a shape 502 corresponding to the number “2” is used as an example pattern. The shape 502 includes an entry point 504a, an exit point 504b, and a plurality of points (shown as 504c) that corresponds to the intended symbol shape.

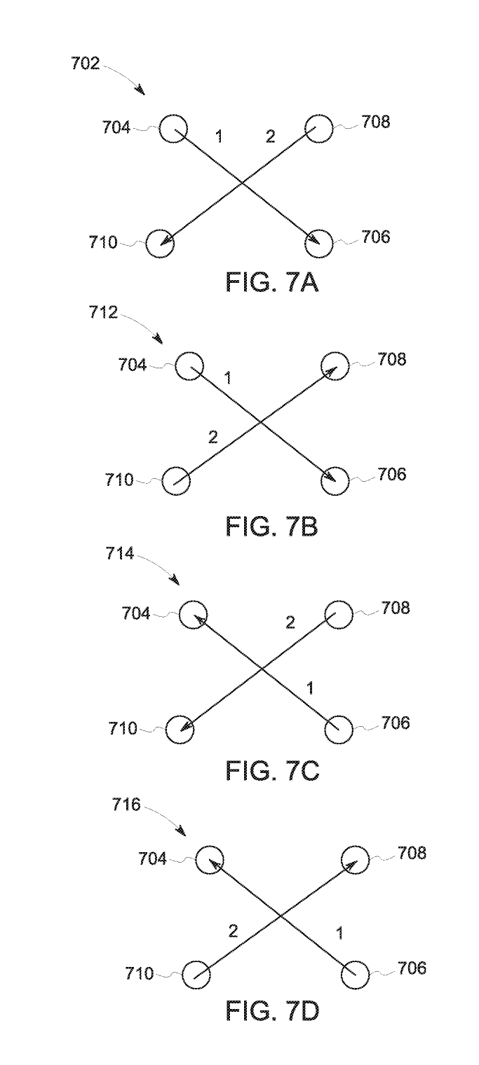

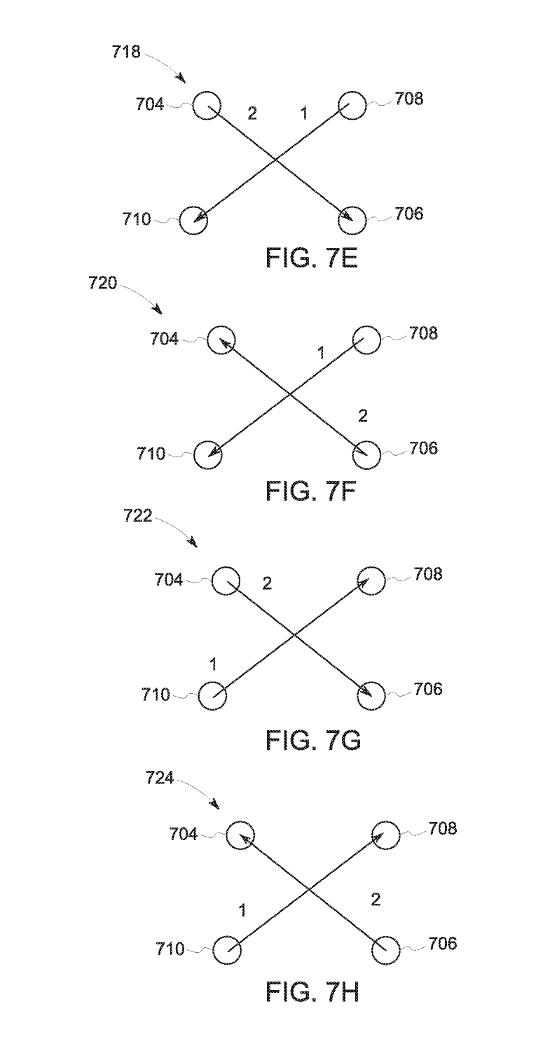

As shown in FIG. 6, a shape 602 corresponding to the letter “x” is used as a pattern. In some embodiments, the pattern is specified based on stroke sequences (i.e., starting point). That is, the entry and exit points have to match a pre-defined definition of the pattern. FIG. 7, comprising panels 7A, 7B, 7C, 7D, 7E, 7F, 7G, and 7H, illustrates example symbol patterns that include stroke ordering. Stoke ordering increases the number of permutations of a given symbol. A symbol that has 2 strokes (e.g., “x”, “4”) have 8 permutations based on starting points of each strokes—thereby allowing single symbols to provide a strong gesturing password. For example, as shown in FIGS. 7A, a first pattern 702 for a symbol “x” includes a first entry point 704 and a first exit point 706 followed by a second entry point 708 and a second exit point 710. A second, and different, pattern 712 also includes a first entry point 704 and a first exit point 706, but now, followed by a second entry point 710 and a second exit point 708. A third, and different, pattern 714 includes a first entry point 706 and a first exit point 704 followed by a second entry point 708 and a second exit point 710. A fourth, and different, pattern 716 includes a first entry point 706 and a first exit point 704 followed by a second entry point 710 and a second exit point 708. A fifth, and different, pattern 718 includes a first entry point 708 and a first exit point 710 followed by a second entry point 704 and a second exit point 706. A sixth, and different, pattern 720 includes a first entry point 708 and a first exit point 710 followed by a second entry point 706 and a second exit point 704. A seventh, and different, pattern 722 includes a first entry point 710 and a first exit point 708 followed by a second entry point 704 and a second exit point 706. A eighth, and different, pattern 724 includes a first entry point 710 and a first exit point 708 followed by a second entry point 706 and a second exit point 704.

It should be appreciated that other symbols in various languages and fields (e.g., mathematical symbols) may be used as a pattern. Different version of the symbols (e.g., capitalized versus non-capitalized versions; script versus non-script; stroke ordering, number of strokes, and font types) may be used without departing from the spirit of the exemplified embodiments.

Gesturing Password

According to an embodiment, the multiple spatially- and pattern-defined touch inputs are received via the transparent input screen to form an authentication pattern (also referred herein to as a gesturing password and a touch-based password). The gesturing password allows an operator of a control system operating in an industrial environment to provide an authentication input to a HMI of the control system where the input has a high-number of permutations to be securable and has a high rate of input accuracy (as, for example, compared to touch keyboards). The HMI system receives a pattern (e.g., a point, a straight line, a curved line, and an alpha-numerical symbol) that is spatially relevant—that is, the pattern is received in conjunction, and associated, with one of multiple regions of the touch screen. The combination of each pattern instance and the respective region of that instance, and the sequence of these combinations provide a high number of unique gesturing passwords.

In some embodiments, the HMI of the control system is configured to present, via the touch-screen display, a visual representation of a graphical element at a border region between each neighbor transparent widgets among the plurality of transparent widgets.

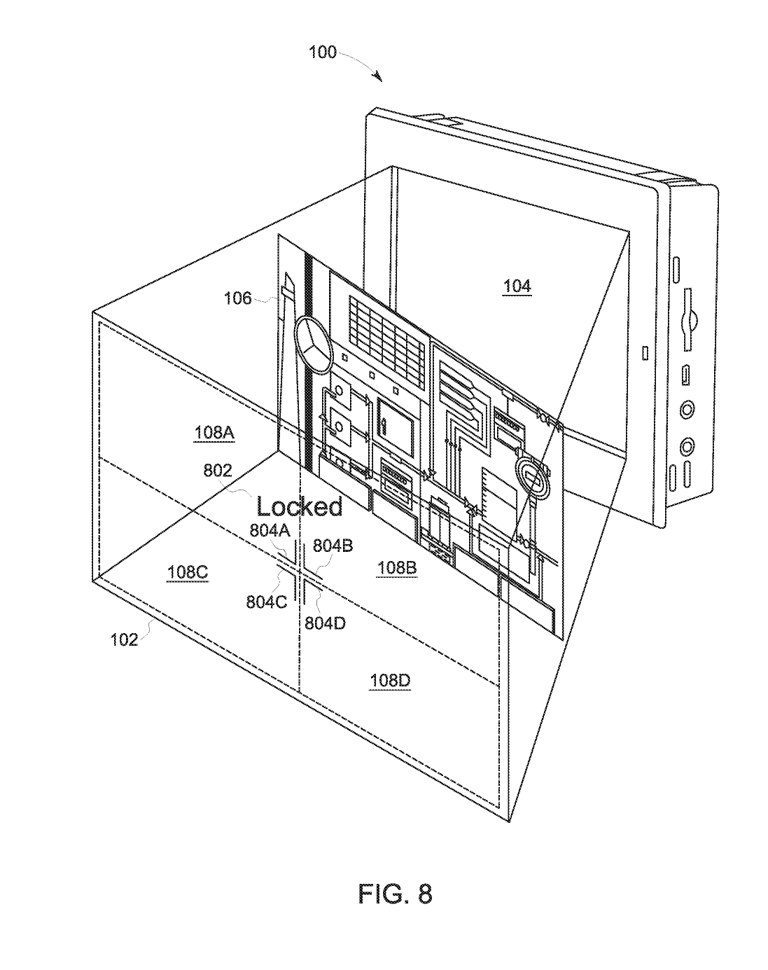

As shown in FIG. 8, the computing device 100 generates, via the application, the input screen 102, via the graphical user interface 104, that renders over or defined within a control screen 106. In addition, the input screen 102 includes a graphical element 802 (shown as a text) to indicate that the control screen 106 is “locked” and authentication inputs in the form of the gesturing password is required. In addition, in some embodiments, the input screen 102 includes graphical elements 804 (shown as 804a, 804b, 804b, and 804d) to visually present boundaries for each respective quadrant and/or regions (shown as 108a, 108b, 108c, and 108d).

In some embodiments, the input screen 102 includes a graphical element to indicate a valid or invalid pattern sequence having been received by the system (e.g., via text, via a flashing color, etc.).

In some embodiments, the input screen 102 indicates (e.g., via text or via flashing colors) that an individual pattern is received.

Process to Define Gesturing Password by Creating a Gesture-Operation Map

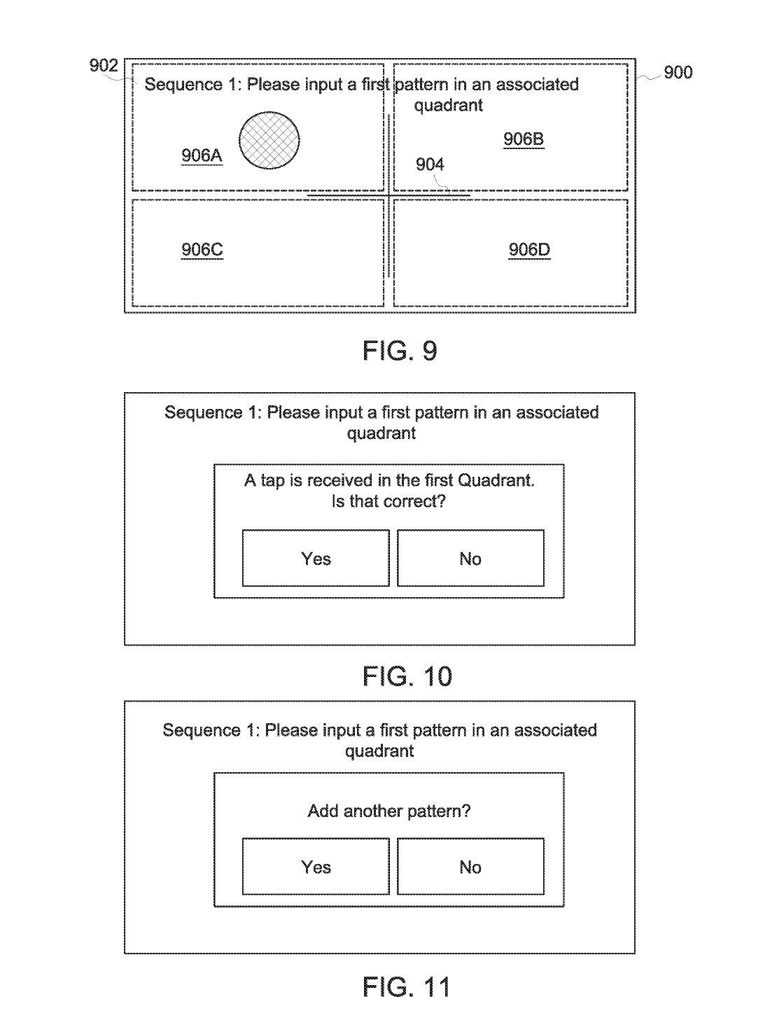

FIGS. 9-11, comprising FIGS. 9, 10, and 11, depict diagrams of a user interface to create a gesturing password, in accordance with an illustrative embodiment.

In FIG. 9, a user interface 900 (i.e., a dialog box or a screen) is presented to receive inputs from a user. The user interface 900 includes text 902 to prompt the operator to provide a first pattern in an associated quadrant. In some embodiments, the user interface 900 is configured to receive the pattern across one or more quadrants. As shown in FIG. 9, the user interface 900 renders a border 904 that defines the boundaries of each of the spatially-defined regions (i.e., referred to in this example as quadrants and shown as regions 906a, 906b, 90c, and 906d).

In FIG. 10, upon receipt of an input that matches to one of a plurality of gesture maps stored in a collection of gesture maps, the user interface 900 prompts the operator to confirm the received pattern and quadrant definition. Where multiple patterns are recognized, the user interface 900 may list all the recognized patterns and prompt the operator to select the intended pattern. In some embodiments, the user interface 900 may list all the recognized patterns and prompt the operator confirm that any and all of such recognized patterns constitute as a matched pattern. To this end, the GUI can use one of multiple patterns (i.e., like patterns) for a specific sequence in the gesturing password.

In FIG. 11, upon receipt of a confirmation of a pattern, the user interface 900 prompts the operator to add another gesturing-pattern and associated-touch-screen-region combination to the gesturing password or to complete and save the gesturing password. Upon selection of that a gesturing password has been completed, the user interface may display a textual description of the gesturing password and prompt the user to re-input the gesturing password. An example of a textual description, corresponding the gesturing password and gesturing map as shown in FIG. 2, can be “DOUBLE_TAP in Quadrant 1 [action 1]; then a TAP in Quadrant 2 [action 2]; then a TAP in Quadrant 3 [action 3]; followed by a SWIPE in Quadrant 4 [action 4].”

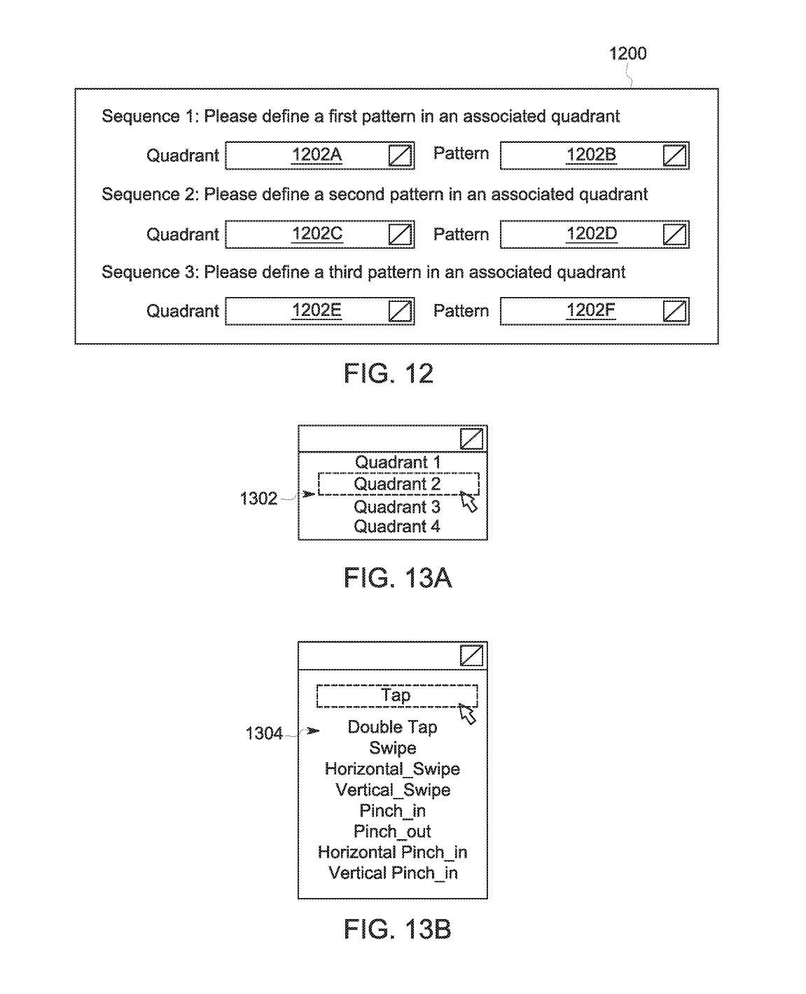

FIGS. 12 and 13, comprising FIGS. 12, 13A, and 13B, depict diagrams of a user interface to create a gesturing password, in accordance with another illustrative embodiment.

In FIG. 12, a user interface 1200 (i.e., a dialog box or a screen) is presented to receive inputs from a user. The user interface 1200 includes input widgets 1202 (shown as drop-down box 1202a, 1202b, 1202c, 1202d, 1202e, and 1202f) to receive (and, in some embodiments, prompt) the operator for a spatially- and pattern-defined touch input sequence. As shown in FIG. 12, the user interface 1200 prompts the user for a spatially- and pattern-defined touch input sequence comprising of three spatially- and pattern-defined touch input patterns, in which each pattern is defined by a region (shown as Quadrant 1202a, 1202c, and 1202e) and a pattern (shown as pattern 1202b, 1202d, and 1202f). In some embodiments, the GUI prompts the operator for a number of pattern-defined touch input sequence that defines a given gesturing password. To which, upon selection of a number, the GUI generates a specific number of sequence inputs (as shown in FIG. 12). In some embodiments, the GUI includes a widget to add additional sequence to the gesturing password.

In other embodiments, the GUI presents a dialog box or screen that is configured to present a default number of sequence inputs (e.g., 4). Each sequence input (comprising corresponding quadrant and pattern fields, e.g., 1202a and 1202b) may have a default value of “none”, which may be modified by the operator to define a given sequence. The GUI may include a widget to add additional sequence to the gesturing password.

FIGS. 13A and FIGS. 13B each depicts diagrams of example drop-down menus associated with the respective quadrant and pattern fields. In FIG. 13A, the drop-down menu 1302 provides visual representation of a list four regions shown as “Quadrant 1”, “Quadrant 2”, “Quadrant 3”, and “Quadrant 4”. In FIG. 13B, the drop-down menu 1304 provide visual representation of a list of pattern-defined touch input patterns. The list shown are merely illustrative and not intended to be exhaustive. Other patterns, for example, those described in relation to FIGS. 2, 3, 4, 5, 6, and 7, among others, may be used without departing from the spirit of the disclosure.

Process to Receive and Use Gesturing Passwords

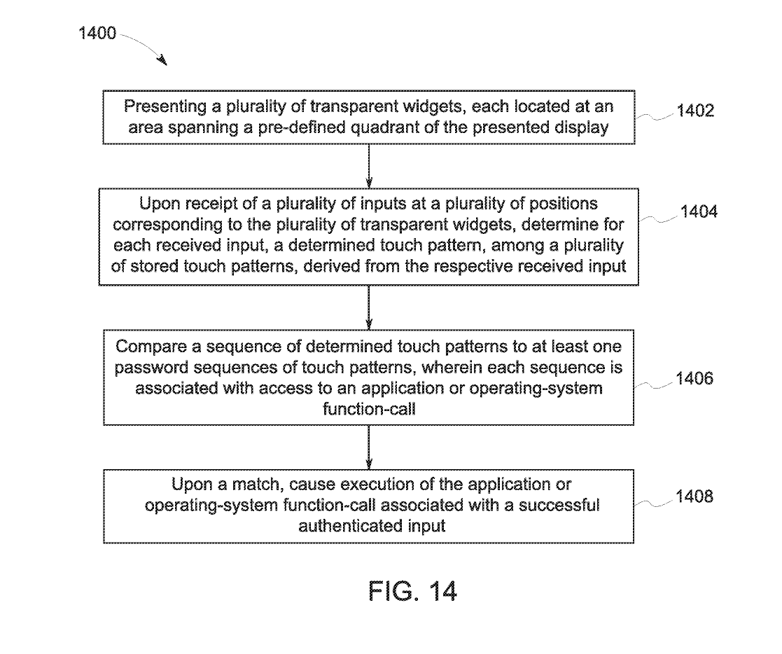

FIG. 14 depicts a method 1400 of receiving a sequence of spatially- and pattern-defined touch inputs, at a graphical user interface, of a touch-screen input device, in an industrial automation system, as a touch-based password for an operating system or an application executing on the device. FIG. 14 is described in relation to FIGS. 1 and 8.

The method 1400, in step 1402, includes presenting, by a processor, via a touch-screen display (e.g., 104) of the touch-screen input device (e.g., 100), a plurality of transparent widgets (e.g., an object (e.g., 108a, 108b, 108c, and 108d) generated and monitored for tactile input in the rendered display or a virtual region in the rendered display monitored for tactile input), each located at an area spanning a pre-defined quadrant of the presented display (e.g., 104).

The method 1400, in step 1404, includes, upon receipt, via the touch-screen display, of a plurality of inputs (e.g., sequences 210a-210d, 302a-302d, 402a-402d, 502, and 602, shown in FIGS. 2-6) at a plurality of positions (e.g., 202, 204, 206, 208) corresponding to the plurality of transparent widgets, determining, by the processor, for each received input, a determined touch pattern, among a plurality of stored touch patterns, derived from the respective received input.

The method 1400, in step 1406, includes comparing, by the processor, a sequence of determined touch patterns to at least one password sequences of touch patterns, wherein each sequence is associated with access to an application or operating-system function-call. In some embodiments, a logic monitors and interprets the gesture applied at a specific location. The logic may compare, following a pre-process operation that determines a path that is associated with the inputs, the determined path to a set of gesture maps, each associated with a given pattern. Multiple gesture maps may be associated with a given library or collection of like maps (e.g., shapes, single actions, symbols, etc.). The HMI may be configured to monitor for certain gestures based on selected library or collection, via a configuration panel that allows selection of collection or classes of maps to be used.

The method 1400, in step 1408, includes, upon a match, causing, by the processor, execution of the application or operating-system function-call associated with a successful authenticated input.

Quadrants

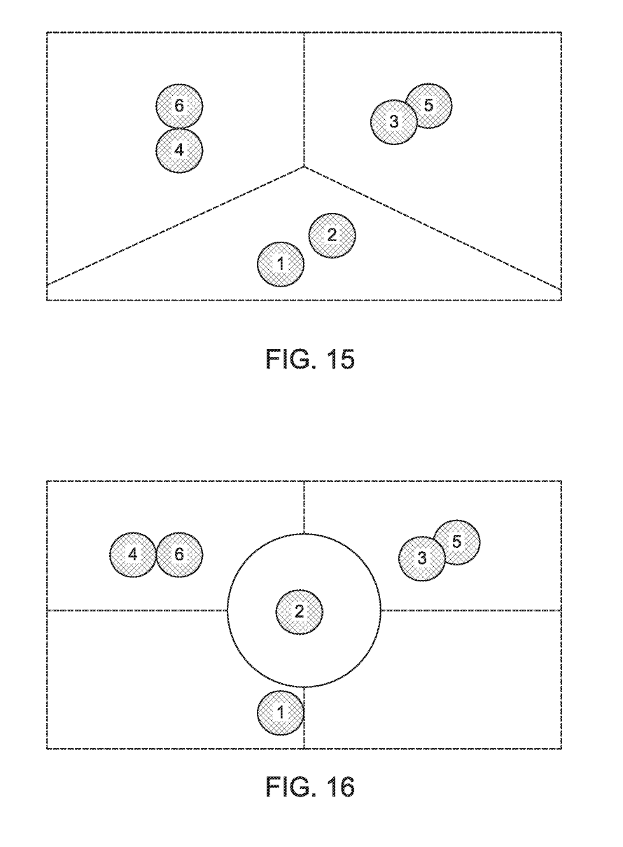

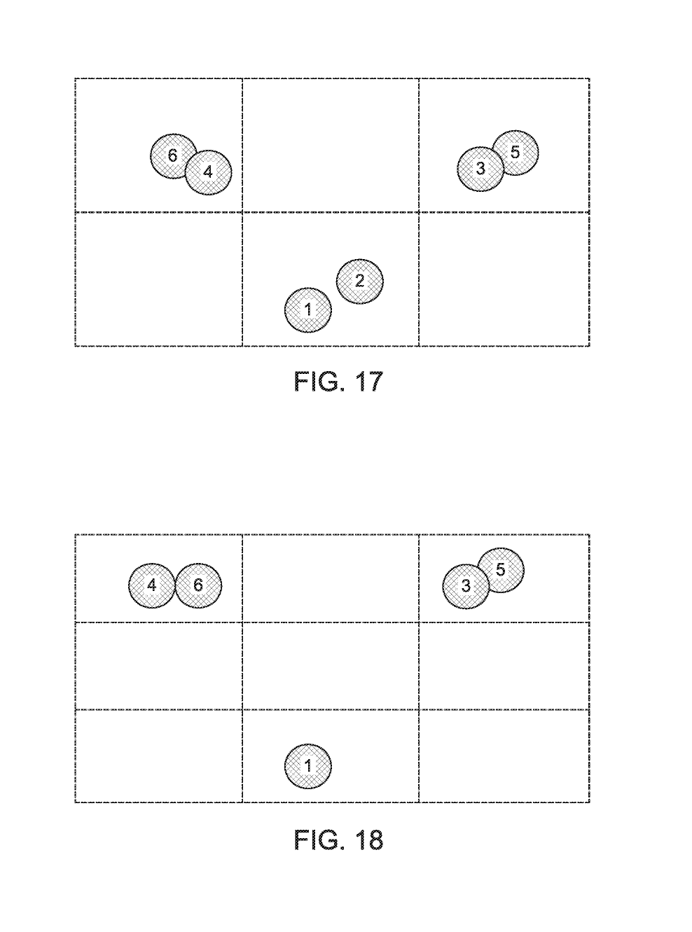

Quadrants as used herein refers to any of such divided regions of the touch screen and such division can be in 2, 3, 4, 5, 6, 7, 8, 9, 10, 11, or 12 divisions. Exemplary embodiments of configuration of divided regions are presented in FIGS. 15, 16, 17, and 18. In FIG. 15, a three-region quadrant is shown. In FIG. 16, a five-region quadrant is shown. In FIG. 17, a six-region quadrant is shown. In FIG. 18, a nine-region quadrant is shown. Here, each of the regions are shown with example inputs and their respective sequences. Other sequences and patterns, described, herein, may be applied to these quadrants without departing from the spirit of the disclosure.

Gesturing Shortcuts

According to another embodiment, the multiple spatially- and pattern-defined touch inputs are received via the transparent input screen to form a shortcut pattern. The spatially- and pattern-defined shortcut facilitates an operator's execution of operations and commands using the location of inputs on a touch screen that avoids the need to have lengthy touch interaction sequence to execute a command/operation on touch based devices. The touch screen defines, for example, four virtual quadrants to which a pattern (i.e., gesture) is applied. The combination of received pattern and the associated spatial regions that received the patterns are used to trigger a pre-defined command, which is configurable by the operator, that is unique to that combination of pattern and location. For example, a “single tap” (i.e., a temporally constraint point input) on first region (i.e., an upper left quadrant of the touch screen) would cause the HMI to change magnification of certain portions of the rendered screen (i.e., “zoom”) the screen, and a “single tap” on the fourth region (i.e., a lower right quadrant of the touch screen) would cause the HMI to render a next navigable control screen. To this end, the same action (i.e., “single tap”) gesture triggers different operation based on the region (e.g., quadrant of the touch screen) to which the action is received by the GUI. The spatially- and pattern-defined shortcut facilitates use of gesturing inputs that are quick to receive, secure, and that are configurable to be associated with a command.

In some embodiments, the spatially- and pattern-defined shortcut facilitates invocation of a specific HMI screen.

In some embodiments, the spatially- and pattern-defined shortcut facilitates invocation of setting values for certain critical control parameters.

In some embodiments the spatially- and pattern-defined shortcut facilitates invocation of a control screen to adjust display brightness of the touch-screen display.

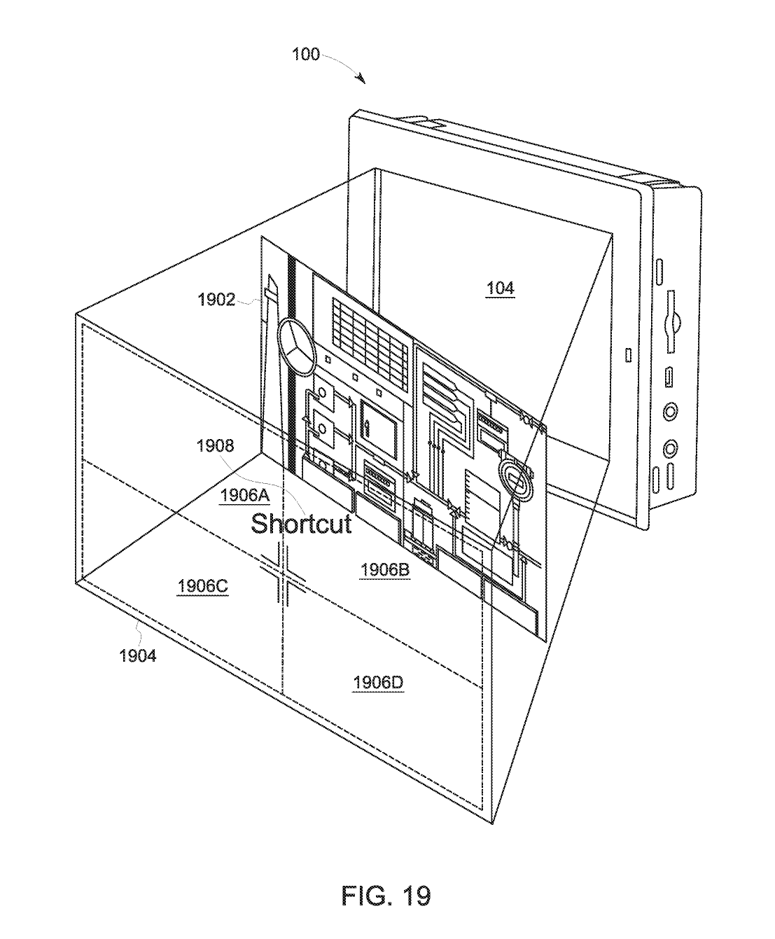

In some embodiments, the shortcut pattern is invoked from a control screen by selection of a shortcut widget presented thereon. FIG. 19 depicts an example graphical user interface (GUI) configured to receive spatially- and pattern-defined touch input shortcut, in accordance with an illustrative embodiment, for example, for example, for use in association with an industrial automation system. As shown in FIG. 19, upon selection of a shortcut widget in a control screen 1902, the GUI is configured to generate a transparent layer or panel (shown as 1904) over the control screen 1902. The transparent layer or panel 1904 includes a plurality of spatially-defined regions 1906 (shown as 1906a, 1906b, 1906c, and 1906d). The transparent layer or panel 1904 may include a text 1908 indicating that a shortcut input is active.

In some embodiments, the shortcut pattern is invoked from a password receiving screen in which a given matched sequence received thereat provides access to the GUI (i.e., unlock the screen) as well as the automatic invocation of an executable command or access to a configuration panel. In such embodiment, the combined password and shortcut GUI further reduces the number of actions needed to be taken by an operator when invoking the executable command or access the configuration panel.

Process to Define Gesturing Shortcuts

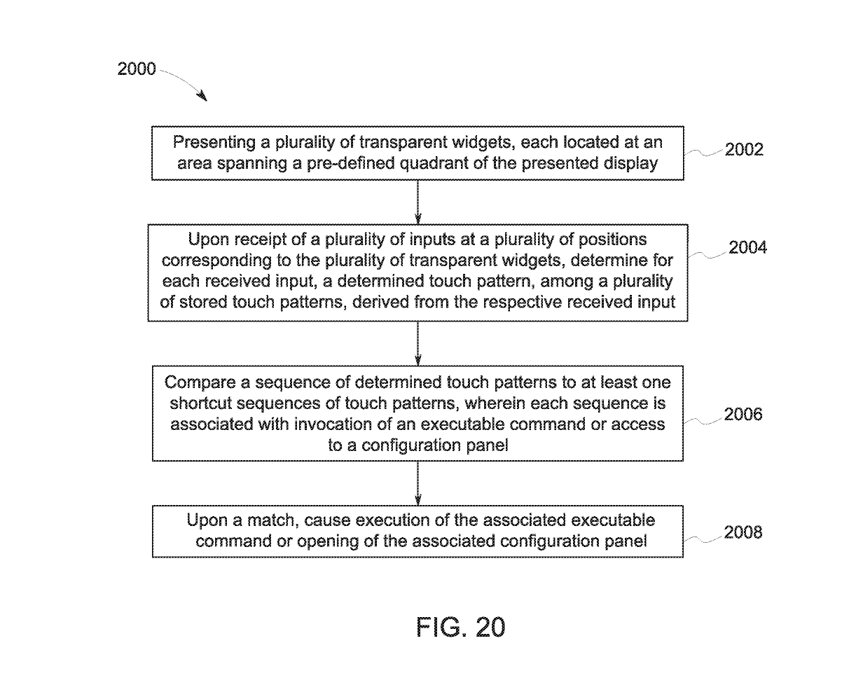

The spatially- and pattern-defined touch shortcuts may be defined as described in relation to FIGS. 9, 10, 11, 12, and 13. In addition, the GUI may prompt the user to associate an executable command or a configuration panel to a given spatially- and pattern-defined touch shortcuts, once defined. FIG. 20 depicts a method 2000 of receiving a sequence of spatially- and pattern-defined touch inputs, at a graphical user interface, of a touch-screen input device, in an industrial automation system, to trigger an associated user interface command (i.e. as a touch-based shortcut). FIG. 20 is described in relation to FIG. 19.

The method 2000, in step 2002, includes presenting, by a processor, via a touch-screen display (e.g., 104) of the touch-screen input device (e.g., 100), a plurality of transparent widgets (e.g., an object (e.g., 1906a, 1906b, 1906c, and 1906d) generated and monitored for tactile input in the rendered display or a virtual region in the rendered display monitored for tactile input), each located at an area spanning a pre-defined quadrant of the presented display (e.g., 104).

The method 2000, in step 2004, includes, upon receipt, via the touch-screen display, of a plurality of inputs (e.g., sequences 210a-210d, 302a-302d, 402a-402d, 502, and 602, shown in FIGS. 2-6) at a plurality of positions (e.g., 202, 204, 206, 208) corresponding to the plurality of transparent widgets, determining, by the processor, for each received input, a determined touch pattern, among a plurality of stored touch patterns, derived from the respective received input.

The method 2000, in step 2006, includes comparing, by the processor, a sequence of determined touch patterns to at least one user-interface (UI) function call associated with i) a determined touch pattern, among a plurality of stored touch patterns, derived from the input and ii) a transparent widget location, among the pre-defined quadrants, derived from the received position. In some embodiments, a logic monitors and interprets the gesture applied at a specific location. The logic may compare, following a pre-processing operation that determines a path that is associated with the inputs, the determined path to a set of gesture maps, each associated with a given pattern. Multiple gesture maps may be associated with a given library or collection of like maps (e.g., shapes, single actions, symbols, etc.). The HMI may be configured to monitor for certain gestures based on selected library or collection, via a configuration panel that allows selection of collection or classes of maps to be used.

The method 2000, in step 2008, includes, upon a match, causing, by the processor, execution of the associated executable command or opening of the associated configuration panel.

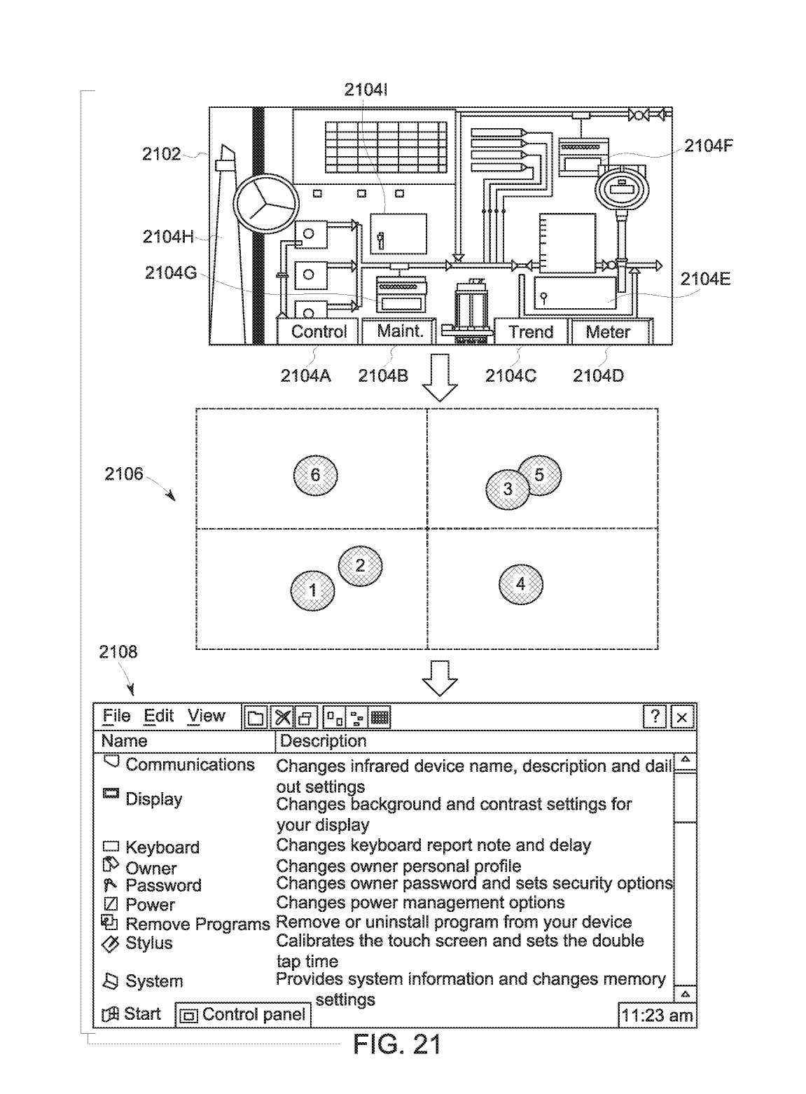

FIG. 21 depicts a diagram of an example process to invoke an associated executable command or to open an associated configuration panel. In FIG. 21, the GUI presents a control screen 2102. The control screen 2102 includes multiple widgets 2104 (shown as 2104a, 2104b, 2104c, 2104d, 2104e, 2104f, 2104g, 2104h, and 2104i) configured to receive an input to adjust a control setting. Upon receipt of a sequence of spatially- and pattern-defined touch shortcuts 2106 and a matched of the sequence to a corresponding command, e.g., to open a configuration panel, the GUI is configured to present the configuration panel 2108. In some embodiments, the sequence of spatially- and pattern-defined touch shortcuts 2106 is also used as a password to authenticate an operation and allow access to the active control of the GUI.

Example Computing Device

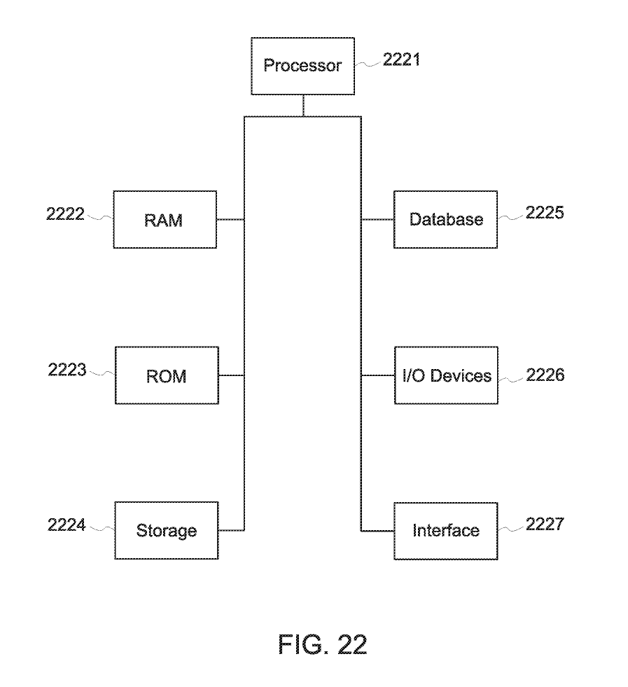

FIG. 22 illustrates an exemplary computer that can be used for configuring hardware devices in an industrial automation system. In various aspects, the computer of FIG. 22 may comprise all or a portion of the development workspace 100, as described herein. As used herein, “computer” may include a plurality of computers. The computers may include one or more hardware components such as, for example, a processor 2221, a random access memory (RAM) module 2222, a read-only memory (ROM) module 2223, a storage 2224, a database 2225, one or more input/output (I/O) devices 2226, and an interface 2227. Alternatively and/or additionally, controller 2220 may include one or more software components such as, for example, a computer-readable medium including computer executable instructions for performing a method associated with the exemplary embodiments. It is contemplated that one or more of the hardware components listed above may be implemented using software. For example, storage 2224 may include a software partition associated with one or more other hardware components. It is understood that the components listed above are exemplary only and not intended to be limiting.

Processor 2221 may include one or more processors, each configured to execute instructions and process data to perform one or more functions associated with a computer for indexing images. Processor 2221 may be communicatively coupled to RAM 2222, ROM 2223, storage 2224, database 2225, I/O devices 2226, and interface 2227. Processor 2221 may be configured to execute sequences of computer program instructions to perform various processes. The computer program instructions may be loaded into RAM 2222 for execution by processor 2221. As used herein, processor refers to a physical hardware device that executes encoded instructions for performing functions on inputs and creating outputs.

RAM 2222 and ROM 2223 may each include one or more devices for storing information associated with operation of processor 2221. For example, ROM 2223 may include a memory device configured to access and store information associated with controller 2220, including information for identifying, initializing, and monitoring the operation of one or more components and subsystems. RAM 2222 may include a memory device for storing data associated with one or more operations of processor 2221. For example, ROM 2223 may load instructions into RAM 2222 for execution by processor 2221.

Storage 2224 may include any type of mass storage device configured to store information that processor 2221 may need to perform processes consistent with the disclosed embodiments. For example, storage 2224 may include one or more magnetic and/or optical disk devices, such as hard drives, CD-ROMs, DVD-ROMs, or any other type of mass media device.

Database 2225 may include one or more software and/or hardware components that cooperate to store, organize, sort, filter, and/or arrange data used by controller 2220 and/or processor 2221. For example, database 2225 may store hardware and/or software configuration data associated with input-output hardware devices and controllers, as described herein. It is contemplated that database 2225 may store additional and/or different information than that listed above.

I/O devices 2226 may include one or more components configured to communicate information with a user associated with controller 2220. For example, I/O devices may include a console with an integrated keyboard and mouse to allow a user to maintain a database of images, update associations, and access digital content. I/O devices 2226 may also include a display including a graphical user interface (GUI) for outputting information on a monitor. I/O devices 2226 may also include peripheral devices such as, for example, a printer for printing information associated with controller 2220, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 2227 may include one or more components configured to transmit and receive data via a communication network, such as the Internet, a local area network, a workstation peer-to-peer network, a direct link network, a wireless network, or any other suitable communication platform. For example, interface 2227 may include one or more modulators, demodulators, multiplexers, demultiplexers, network communication devices, wireless devices, antennas, modems, and any other type of device configured to enable data communication via a communication network.

Example Industrial Automation Systems

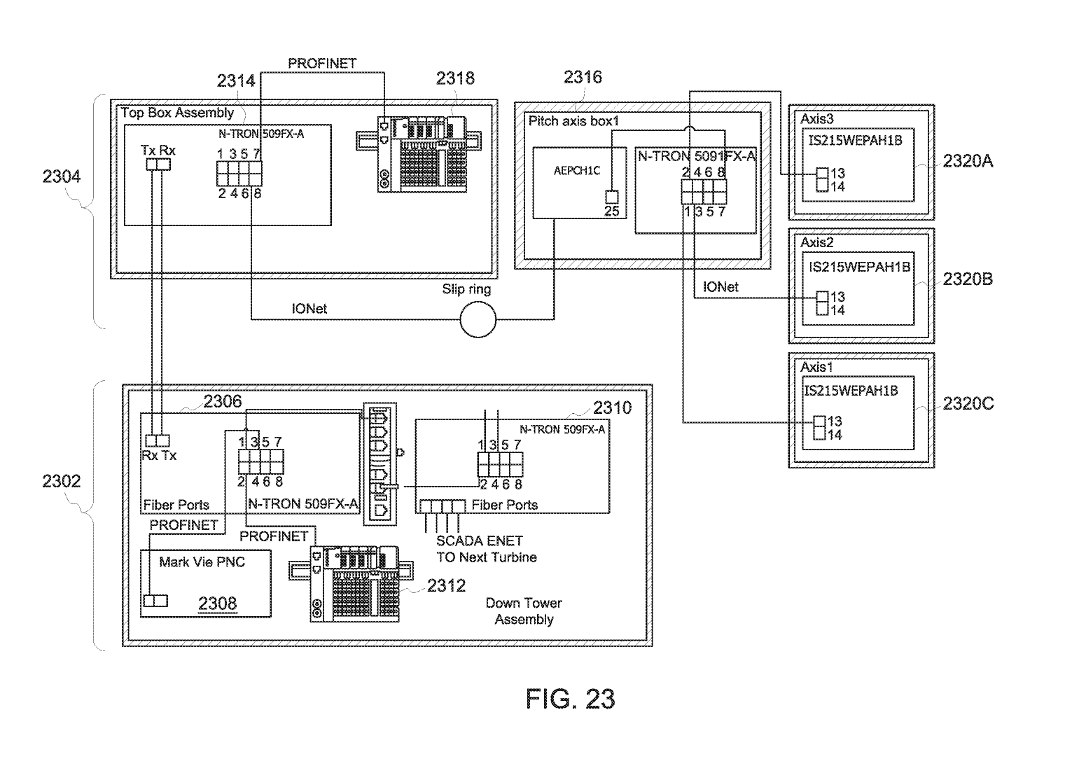

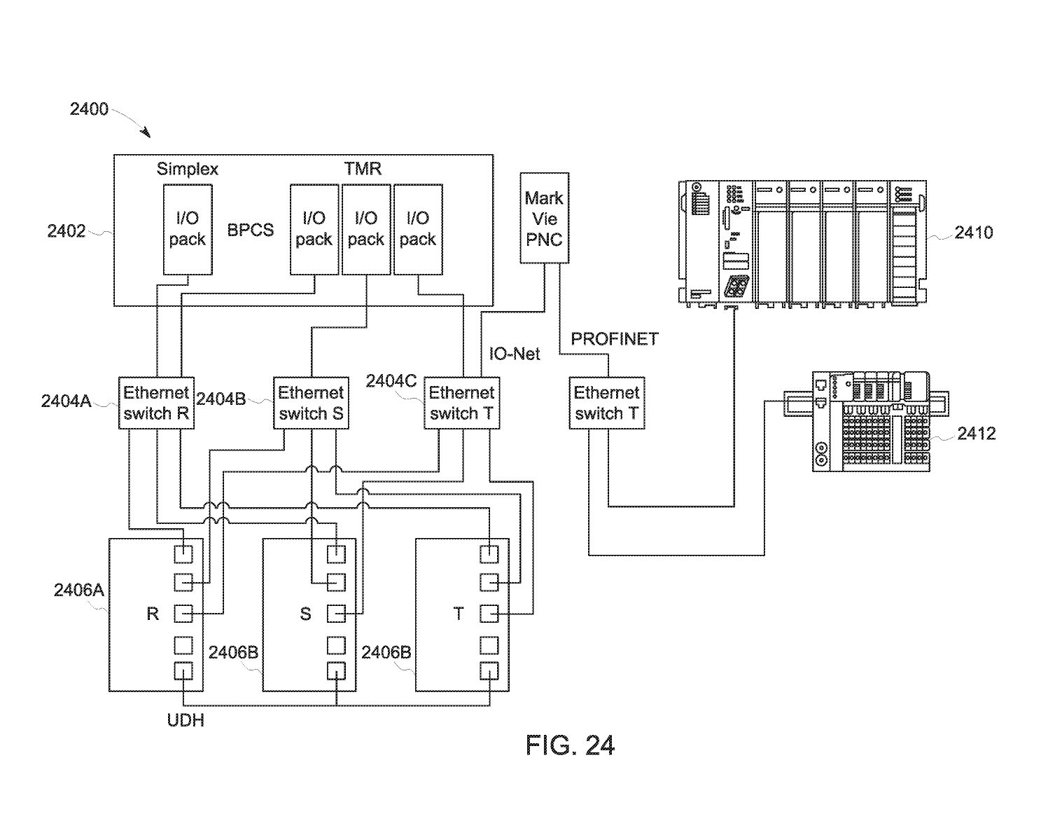

FIGS. 23 and 24 are diagrams of example industrial automation systems, in accordance with an illustrative embodiment. As shown in FIG. 23, the industrial automation system 2300 comprises an example control system for a wind turbine generator and includes a first local network 2302 located at the base of the wind turbine connected to a second local network 2304 located at the turbine cab. The first local network 2302 includes a network device 2306 having a communication link (e.g., via Profinet, Profibus, InterCAD) and communicates with a controller 2308 (shown as “Mark Vie 2308”), a SCADA system 2310 to connect to other wine turbine generators, and a controller 2312 to monitoring conditions at the base of the tower. The second local network 2304 includes a second network device 2314 having a communication link (e.g., via Profinet, Profibus, InterCAD) and communicates with controllers 2316 for each pitch axis (e.g., that regulates control of the pitch, yaw, and rotation of one of the multiple blades of the turbine), and controller 2318 for monitor conditions at the nacelle of the tower. The controllers 2316 connect to controllers 2320a, 2320b, 2320c for each of the blade rotatable axis.

As shown in FIG. 24, the industrial automation system 2400 comprises an example control system for a power plant and include a Mark VIe controller 2402 for core engine controls. To provide redundancy, the controller 2402 interfaces to sets of network devices (shown as Ethernet switches 2404a, 2404b, and 2404c) that connects to a set of controllers 2406a, 2406b, 2406c. The controller 2402 further connects to a Mark Vie PNC controller 2408 which couples to auxiliary controllers 2410, 2412 in the power plant.

Each of the controllers 2306, 2308, 2310, 2318, 2316, 2320, 2402, 2406, 2410, 2412 may include, individually, tens to hundreds of connected modules and submodules.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain. It will be apparent to those skilled in the art that various modifications and variations.

What is claimed is:

1. A method of receiving a sequence of spatially- and pattern-defined touch inputs, at a graphical user interface, of a touch-screen input device, in an industrial automation system, as a touch-based password for an operating system or an application executing on the device, the method comprising:
presenting, by a processor, via a touch-screen display of the touch-screen input device, a plurality of transparent widgets, each located at an area spanning a pre-defined quadrant of the presented display;
upon receipt, via the touch-screen display, of a plurality of inputs at a plurality of positions corresponding to the plurality of transparent widgets, determining, by the processor, for each received input, a determined touch pattern, among a plurality of stored touch patterns, derived from the respective received input;
comparing, by the processor, a sequence of determined touch patterns to at least one password sequences of touch patterns, wherein each sequence is associated with access to an application or operating-system function-call; and
upon a match, causing, by the processor, execution of the application or operating-system function-call associated with a successful authenticated input.

2. The method of claim 1, wherein each of the plurality of password sequence of touch patterns comprises a number of unique touch patterns selected from the group consisting of 2, 3, 4, 5, 6, 7, 8, 9, 10, 11, 12, 13, 14, 15, and 16.

3. The method of claim 1, wherein a successful authenticated input includes a determined touch pattern in each of the plurality of presented transparent widgets.

4. The method of claim 1, wherein a successful authentication input includes a determined touch pattern in at least two of the plurality of presented transparent widgets.

5. The method of claim 1, wherein the determined touch pattern comprises a contiguous pattern selected from the group consisting of a point, a line, an arc, a symbol, and a polygonal shape.

6. The method of claim 1, wherein the determined touch pattern comprises two or more contiguous patterns, each selected from the group consisting of a point, a line, an arc, a symbol, and a polygonal shape.

7. The method of claim 1, comprising:
upon receipt, via the touch-screen display, of a second input i) originating at a first position on the presented display associated with a first transparent widget presented at a first quadrant and ii) terminating at a second position on the presented display associated with a second transparent widget presented at a second quadrant, determining, by the processor, i) a multi-quadrant touch pattern, derived from the second input, and ii) transparent-widget pair locations, among the pre-defined quadrants, derived from the received positions; and
caching, by the processor, the determined multi-quadrant touch pattern and quadrant positions associated therewith as an element in a determined sequence.

8. The method of claim 7, comprising:
upon receipt, via the touch-screen display, of a third input having traversed across i) a first transparent widget presented at a first quadrant, ii) a second transparent widget presented at a second quadrant, and iii) a third transparent widget presented at a third quadrant, determining, by the processor, i) a tri-quadrant touch pattern, derived from the third input, and ii) at least three transparent-widget locations, among the pre-defined quadrants, derived from the received positions; and
caching, by the processor, the determined tri-quadrant touch pattern and quadrant positions associated therewith as an element in a determined sequence.

9. The method of claim 1, comprising:
presenting, by the processor, via the touch-screen display, a visual representation of a graphical element at a border region between each neighbor transparent widgets among the plurality of transparent widgets.

10. The method of claim 1, comprising:
presenting, by the processor, via the touch-screen display, a visual representation of a determined touch pattern being received.

11. The method of claim 10, wherein the visual representation comprises a graphical element having a pattern of the determined touch pattern.

12. The method of claim 1, comprising:
presenting, by the processor, via the touch-screen display, a visual representation of a graphical element associated with a submit password for authentication.

13. The method of claim 1, comprising:
presenting, by the processor, a visual representation of a password configuration window, the password configuration window having a plurality of selectable input fields, including a first selectable input field and a second selectable input field,
wherein the first selectable input field includes a list of one or more quadrants associated with execution of a password, and
wherein the second selectable input field includes a list of touch patterns, to be used in conjunction with the selected one or more quadrants selected in the first selectable input field, the selected touch pattern being associated with the password.

14. The method of claim 13, wherein the plurality of selectable input fields of the password configuration window comprises a third selectable input field,
wherein the third selectable input field includes a list of configuration options to associate to a specific password.

15. The method of claim 13, comprising:
presenting, by the processor, in the password configuration window, a visual representation of a password sequence derived from each inputs to the plurality of selectable input fields.

16. The method of claim 1, comprising:
presenting, by the processor, a visual representation of a first password configuration dialog box, the first dialog box including a first selectable input field and a second selectable input field, wherein the first selectable input field includes a list of one or more quadrants associated with execution of a password, and wherein the second selectable input field includes a list of touch patterns, to be used in conjunction with the selected one or more quadrants selected in the first selectable input field, the selected touch pattern being associated with a first touch-pattern in a sequence of touch-patterns defining a touch-based password; and
upon receipt of inputs for each of the first and second selectable fields, presenting, by the processor, a visual representation of a second password configuration dialog box, the second dialog box including a third selectable input field and a fourth selectable input field, wherein the third selectable input field includes a list of one or more quadrants associated with execution of a password, and wherein the fourth selectable input field includes a list of touch patterns, to be used in conjunction with the selected one or more quadrants selected in the third selectable input field, the selected touch pattern being associated with a second gesture in the sequence of gestures defining the gesture-based password.

17. The method of claim 1, comprising:
interrogating for a touch-based password for each control command selected from the group consisting of viewing a HMI screen, setting control values or parameters associated with operation of an equipment within the industrial automation system, and changing configuration of the touch-screen input device.

18. The method of claim 1, comprising:
presenting, by the processor, via the touch-screen display, a graphical widget to input a text-based password; and
in response to selection of the graphical widget, presenting, via the touch-screen display, a dialog box to receive a text-based password.

19. An apparatus (e.g., in an industrial automation system) that authenticates a password inquiry via a touch-based password comprising a sequence of spatially- and pattern-defined touch inputs, at a graphical user interface of the apparatus, the apparatus comprising:
a touch-screen display;
a processor operatively coupled to the touch-screen display; and
a memory operatively coupled to the processor, the memory having instructions stored thereon, wherein the instructions, when executed by the processor, cause the processor to:
present, via the touch-screen display, a plurality of transparent widgets, each located at an area spanning a pre-defined quadrant of the presented display;
upon receipt, via the touch-screen display, of a plurality of inputs at a plurality of positions corresponding to the plurality of transparent widgets, determine, for each received input, a determined touch pattern, among a plurality of stored touch pattern, derived from the respective received input;
compare a sequence of determined touch patterns to at least one password sequence of touch patterns, wherein each sequence is associated with access to an application or operating-system function-call; and
upon a match, cause execution of the application or operating-system function-call associated with a successful authenticated input.

20. A non-transitory computer-readable medium that authenticates a password inquiry via a touch-based password comprising a sequence of spatially- and pattern-defined inputs, at a graphical user interface, received at a touch-screen input, the computer-readable medium having instructions stored thereon, wherein the instructions, when executed by the processor, cause the processor to:
present, via the touch-screen display, a plurality of transparent widgets, each located at an area spanning a pre-defined quadrant of the presented display;
upon receipt, via the touch-screen display, of a plurality of inputs at a plurality of positions corresponding to the plurality of transparent widgets, determine for each received input, a determined touch pattern, among a plurality of stored touch pattern, derived from the respective received input;
compare a sequence of determined touch patterns to a plurality of password sequence of touch patterns, wherein each sequence is associated with access to an application or operating-system function-call; and
upon a match, cause execution of the application or operating-system function-call associated with a successful authenticated input.

21. A method of receiving a sequence of spatially- and pattern-defined touch inputs, at a graphical user interface, of a touch-screen input device, in an industrial automation system, as a touch-based password for an operating system or an application executing on the device, the method comprising:
presenting, by a processor, via a touch-screen display of the touch-screen input device, a plurality of widgets for a control application in an industrial automation system, wherein each of the plurality of widgets is associated with a control function call of the control application and is presented in a non-responsive state;
upon receipt, via the touch-screen display, of a plurality of inputs at a plurality of positions, at the graphical user interface, determining, by the processor, for each received input, i) a determined touch pattern, among a plurality of stored touch patterns, derived from the respective received input and ii) an associated pre-defined quadrant of the presented display, wherein each associated pre-defined quadrant is associated with a given determined touch pattern, and wherein each pre-defined quadrant spans a pre-defined area over the graphical user interface;
comparing, by the processor, a sequence of determined touch patterns to at least one password sequences of touch patterns, wherein each sequence is associated with access to an application or operating-system function-call; and
upon a match, causing, by the processor, each of the plurality of widgets to be presented in a responsive state such that a receipt of an input at the plurality of widgets causes execution of the associated control function-call of the control application.
